(19) United States
(12) Patent Application Publication
(10) Pub. No.: US 2014/0069669 A1
(43) Pub. Date: Mar. 13, 2014

(54) System and Method for Sod Harvesting using a Guide

(71) Applicant: Richard Leon Shuman, Crosby, TX (US)

(72) Inventor: Richard Leon Shuman, Crosby, TX (US)

(21) Appl. No.: 13/614,386

(22) Filed: Sep. 13, 2012

(51) Int. Cl. A01B 49/04; A01B 79/02; A01B 45/04

(52) U.S. Cl. 172/1; 172/19

(57) ABSTRACT

The following disclosure relates to an improved system and method for harvester harvesting sod using a guide. Specifically, the sod harvester can comprise a front guide, a middle guide, and a back guide. The front guide can be capable of receiving a harvested portion of a grass strip. The middle guide can be connected to the front guide, and can be curved inward such that at least a portion of the guide is positionable under a conveyor frame. The back guide can be connected to the middle guide, and the back guide can be configured to horizontally displace the grass strip by moving the grass strip through the guides.

### BACKGROUND

This disclosure relates to an improved system and method for sod harvesting using a guide.

Sodding is the process of laying a continuous cover of grass sod on bare grounds. Sod or turf is grown and transplanted on soil areas to serve as a cover on the ground and to create an image of a lush lawn. Moreover, sodding is practiced as a permanent erosion control, which protects the soil from being damaged by wind and rain. Additionally, turf grass can help reduce high temperature and help to cool the atmosphere. The aesthetical and environmental benefits brought by sodding have increased market for sod. As such, sod is cultivated, produced, and harvested to supply the demand in the market.

During recent years, sod has been harvested using a mechanical harvester. A mechanical sod harvester harvests a wide strip of sod quickly, leaving a strip of the field bare. Though mechanical sod harvester serves its purpose, sod can take several months or years to grow back and mature. It takes significant amount of time for the sod, such as St. Augustine grass, to spread into gaps created by the sod harvester, as the gap can be as much as two feet wide. While smaller gaps can be cut, the sod strips can not be too narrow as they become tedious to replant in other locations.

As such, it would be useful to have an improved system and method for harvesting sod using a guide.

### SUMMARY

The following disclosure relates to an improved system and method for harvesting sod using a guide. Specifically, the sod harvester can comprise a front guide, a middle guide, and a back guide. The front guide can be capable of receiving a harvested portion of a grass strip. The middle guide can be connected to the front guide, and can be curved inward such that at least a portion of the guide is positionable under a conveyor frame. The back guide can be connected to the middle guide, and the back guide can be configured to horizontally displace the grass strip by moving the grass strip through the guides.

The disclosure also relates to an improved method for harvesting sod. Specifically, the method can comprise horizontally displacing a grass strip by moving the grass strip through a guide. The guide can comprise a front guide, a middle guide and a back guide. The middle guide can be curved inward such that at least a portion of the guide is positioned under a conveyor frame.

### BRIEF DESCRIPTION OF THE DRAWINGS

FIG. 1 illustrates a field growing one or more patches of sod.

FIG. 2 illustrates a sod harvester.

FIG. 3 illustrates a harvester comprising a plurality of cutter blades, a cutter frame, a conveyor frame, a guide and a cutting head.

FIG. 4A illustrates a middle buster comprising a shank and a foot piece.

FIG. 4B illustrates middle buster and a wheel attached on a guide.

FIG. 5 illustrates an aerial view of a field before a sod strip can be moved in the center of a harvested plot.

FIG. 6 illustrates an aerial view showing a sod strip directed in the middle portion of a harvested plot.

FIG. 7 illustrates an embodiment of a guide comprising a plurality of rollers.

FIG. 8 illustrates an inclined embodiment of a guide.

### DETAILED DESCRIPTION

Described herein is an improved system and method for harvesting sod using a guide. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

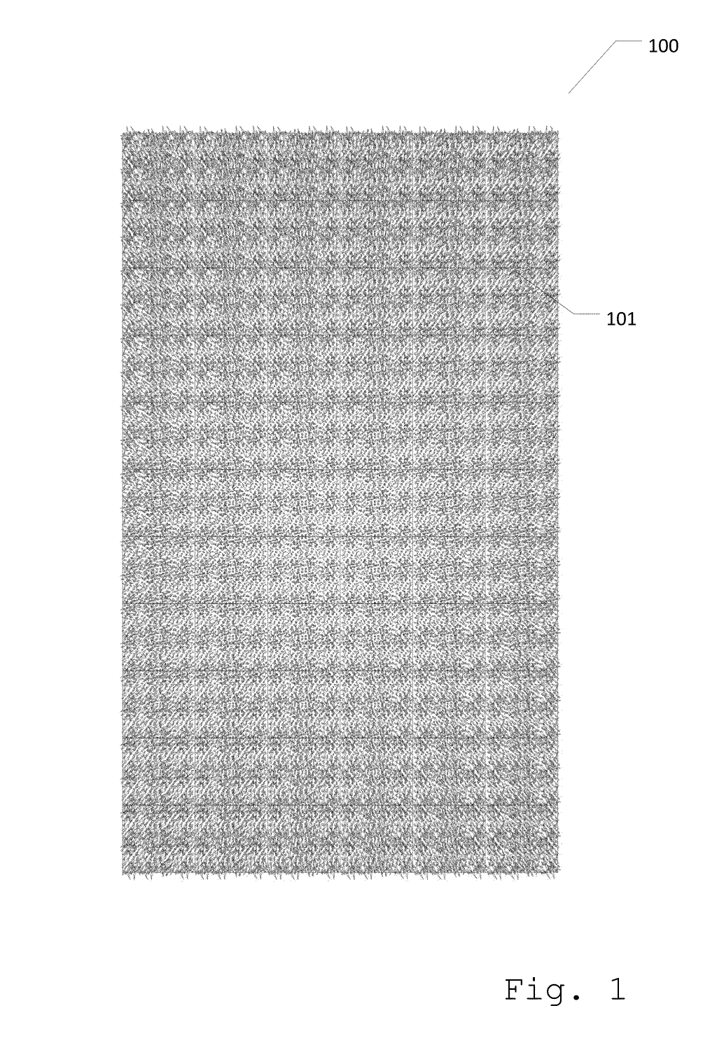

FIG. 1 illustrates a field 100 growing one or more patches of sod 101. Field 100 can be an area cultivated and suitable for growing of sod 101. Sod 101 can be any type of grass that includes but is not limited to St. Augustine grass. St. Augustine is exemplary for the process described because this process is particularly useful with grass that produces runners. With St. Augustine grass, if there is a bare area in the field 100, runners from the sod will grow into the bare area, eventually filling it in.

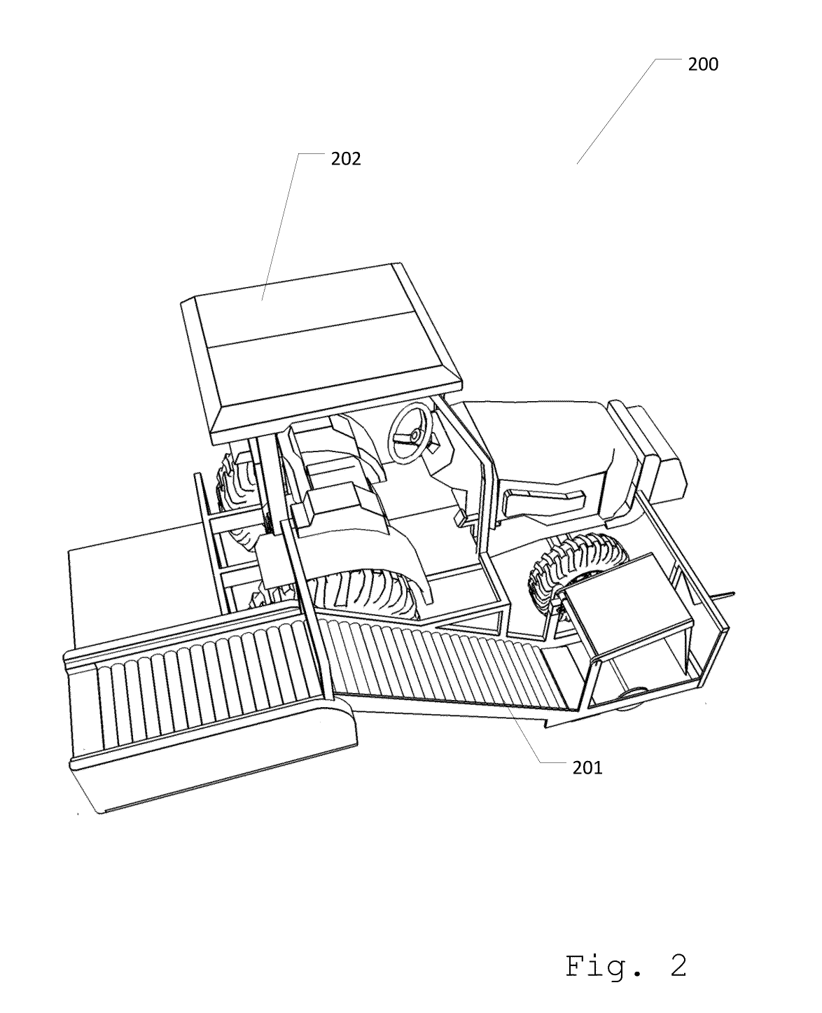

FIG. 2 illustrates a sod harvester 200 comprising a harvester 201 and a tractor 202. Harvester 201 can be any type of machine equipped for cutting sod 101 growing on field 100. Harvester 201 can use any type of cutting mechanism, which can include but are not limited to rotary mower, reel type mower, and/or flail mower. Tractor 202 can be any vehicle that can be used to carry or attach harvester 201. Tractor 202 can haul heavy equipment or machine such as harvester 201. In one embodiment, tractor 202 can specifically mount harvester 201. In such embodiment, harvester 201 can be attached and/or detached from tractor 202. In another embodiment, tractor 202 can be a standard farm vehicle that provides power and traction to mechanize variety of tasks. Further, in another embodiment tractor 202 and harvester 201 can be attached together and be considered as single equipment.

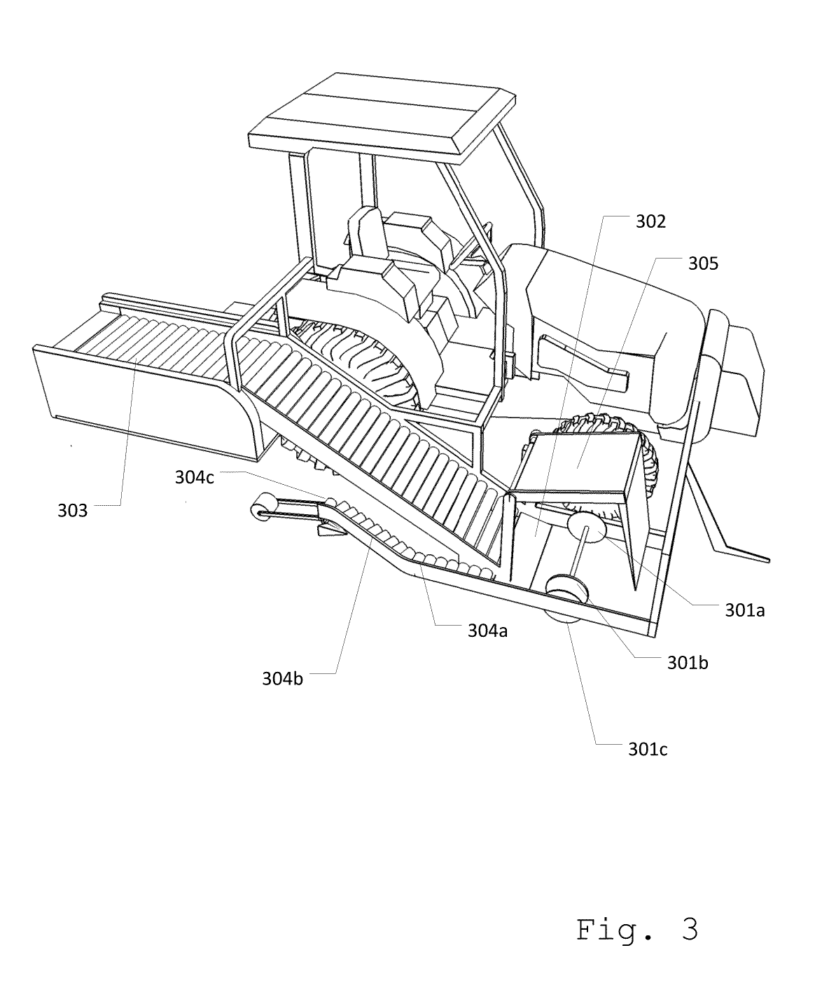

FIG. 3 illustrates a harvester 201 comprising a plurality of cutter blades 301, a cutter frame 302, a conveyor frame 303, a guide 304, and a cutter head 305. Cutter blades 301 can be used to mark, slice, and/or frame strips of sod 101 to be harvested. As such, cutter blades 301 can be made of any durable material such as a rust resistant metal and can be substantially circular. Furthermore, cutter blades 301 can rotate on surface the surface of field 100, which can slice transverse edges creating a contour on field 100.

Cutter frame 302 can be used to cut strips of sod 101 from field 100. Cutter frame 302 can be wide enough to cover the width of conveyor frame 303 and guide 304. Furthermore, cutter frame 302 can have adjustable depth control to ensure sod 101 can be cut with uniform thickness. Cutter frame 302 can be positioned behind and in direct line with cutter blades 301 to ensure straight and consistency in width of sod 101. Further, cutter frame 302 can be pushed to the ground towards cutting blades 301 to harvest sod 101.

Conveyor frame 303 can be placed at the rear of cutter frame 302 to catch or hold wide strips of harvested sod 101. Conveyor frame 303 can be used to collect elongated strips of sod 101 to be stacked in either roll or slab configuration. Guide 304 can be a smaller frame placed in the outer side of conveyor frame 303. In one embodiment, guide 304 can be removable from conveyor frame 303. In such embodiment, guide 304 can attach to conveyor frame 303 through any fastening device that includes but are not limited to clamps, screws, nuts, and bolts. In another embodiment, guide 304 can be permanently attached to conveyor frame 303 through a weld. Guide 304 can be a tool used to move narrow strip of sod 101. Furthermore, guide 304 can lead the narrow strip of sod 101 back to the harvested portion of field 100. Guide 304 can comprise a front guide 304a, a middle guide 304b, and a back guide 304c. Front guide 304a can be a portion of guide 304 that is vertically parallel with conveyor frame 303. Middle guide 304b can be the middle portion of guide 304 that slants inwardly towards and underneath conveyor frame 303. Middle portion of guide 304 can slightly bent downward and towards the surface of field 100. Back guide 304c can be the vertical rear end portion of guide 304. Cutter head 305 can be made from a metal or other durable material that can be used to cut harvested patch of sod 101 vertically. Cutter head 305 can float or be suspended on a harvester 201, thus can be operated and moveable in a vertical direction. Cutter head 305 can be configured to cut off a desired length of sod 101.

Further, for purposes of these disclosure cutter blades 301 can comprise an inner blade 301a, a middle blade 301b, and an outer blade 301c. Moreover, cutter blades 301 can be horizontally distributed and parallel with cutter frame 302, wherein cutter blades 301 can be placed in front of cutter frame 302 Inner blade 301a can vertically align with the inner edge of conveyor frame 303 while outer blade 301c can vertically align with the outer edge of guide 304. Furthermore, middle blade 301b positioned in between inner blade 301a and outer blade 301c can be aligned vertically with the outer edge of conveyor frame 303 and the inner edge of guide 304.

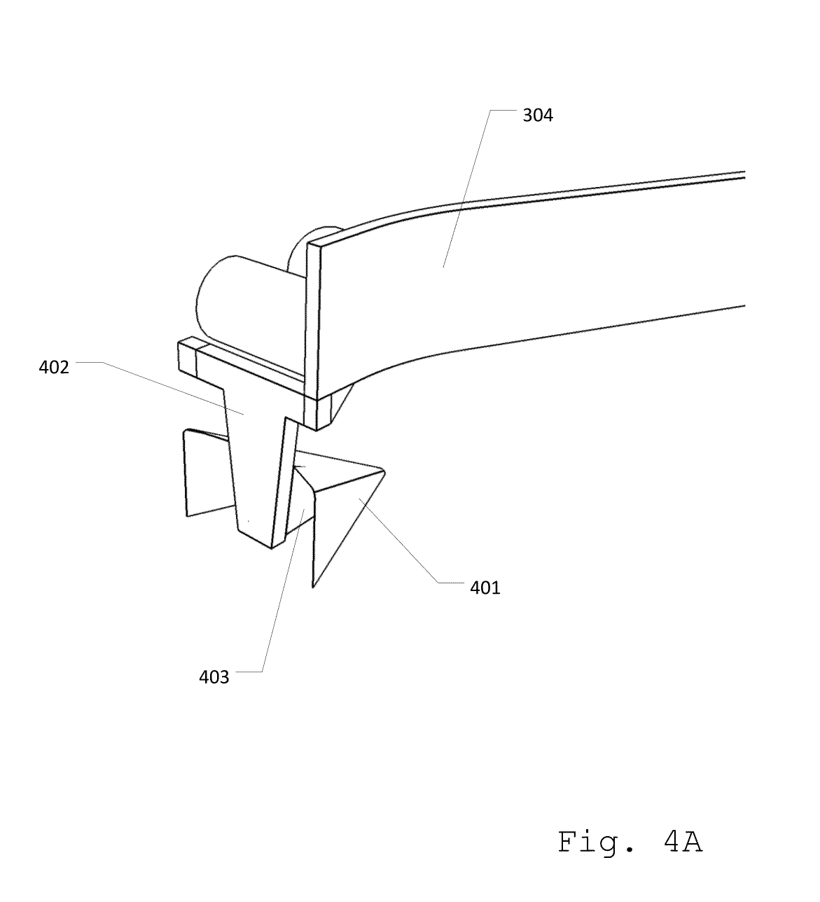

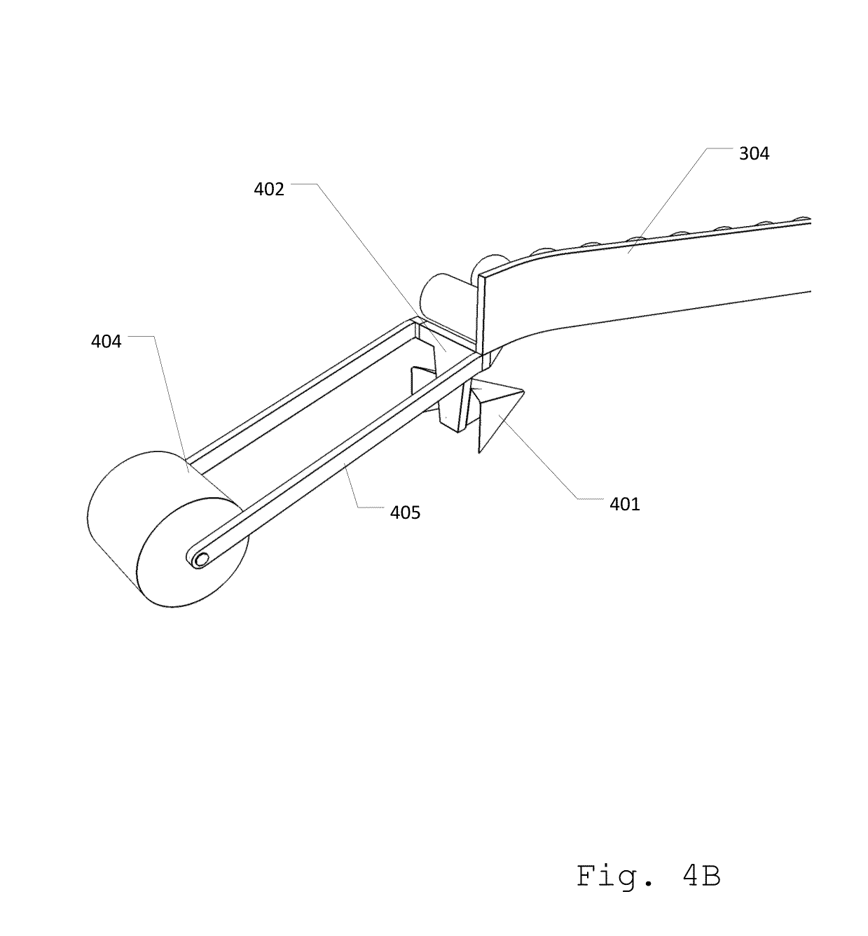

FIG. 4A illustrates a middle buster 401 comprising a shank 402 and a foot piece 403. Middle buster 401 can be a tool forming a cone shape, which can be used to dig and/or plow the ground. Middle buster 401 can open a furrow and throws dirt or soil in both directions. The tip of middle buster 401 can be pointed towards the forward direction of sod harvester 200. Thus, the pointed tip of middle buster 401 can be used to break up the top layer of a harvested field 100. Shank 402 can be a flat shaft, which can perpendicularly attach at the rear end of guide 304. Shank 402 can be a rigid tool used to connect middle buster 401 with guide 304.

Foot piece 403 can be a flat metal in a shape of a wrench that can be attached at the bottom end of shank 402. Foot piece 403 can have a u-shape opening that can be compatible with middle buster 401. Foot piece 403 can be horizontally attached at the bottom end of shank 402 thus making foot piece 403 parallel with field 100. In one embodiment, foot piece 403 can be attached to shank 402 through any type of fastener such as bolts and screws that can enable foot piece 403 to be sturdily attached with shank 402. In such embodiments, foot piece 403 can be mateable with shank 402 wherein middle buster 401 can be held in between the u-shaped opening of foot piece 403 through any fastening device, such as screws, nuts, and/or bolts. As such, shank 402 can provide enough force for middle buster 401 to hold a fixed position. In another embodiment, foot piece 403 and shank 402 can be permanently attached together, and be considered as a single device.

FIG. 4B illustrates middle buster 401 and a planter 404 attached on guide 304. In one embodiment, planter 404 can be a rolling component positioned directly behind middle buster 401. As such, as middle buster 401 can create a trench inn harvested field 100, and planter 404 can flatten and/or tighten narrow grass strip 101 into the trench. In one embodiment, middle buster 401 and planter 404 can be mounted on a tool bar 405 that can be attached at the rear end of guide 304. Tool bar 405 can be a metallic rod vertically attached at the rear end portion of guide 304 through a weld, a clamp and/or other fastening material such as screw, nuts, and bolts. In such embodiment, shank 402 can be mounted perpendicularly to tool bar 405 and enables middle buster 401 be leveled into the surface of field 100. As such, middle buster 304 can be lowered or raised and be adjusted according to the desired depth of trench to be created on field 100. Further, in another embodiment, middle buster 401 can be a sweeper that can brush up debris from sod 101, as harvester 201 moves. As such, middle buster 401 can be used for removal of debris such as leaves, twigs, and/or litters on from sod 101.

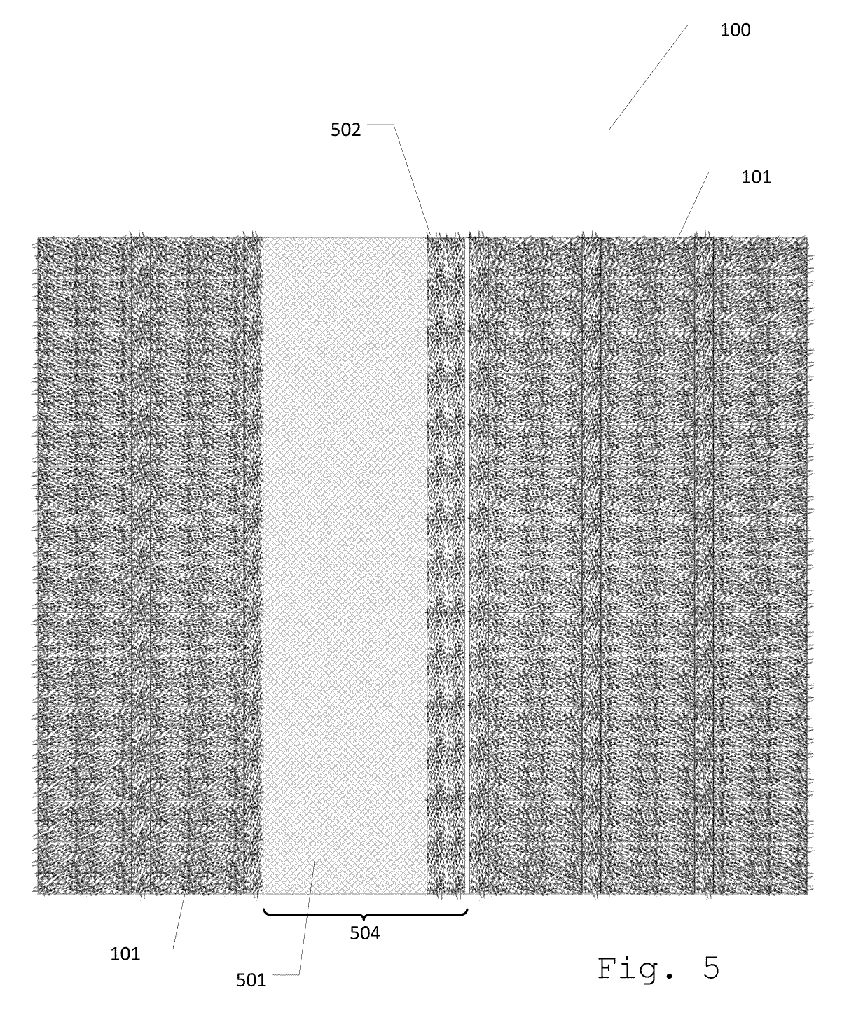

FIG. 5 illustrates an aerial view of field 100 before a narrow grass strip 502 can be moved in the center of a harvested plot 504. As sod harvester 200 moves through field 100, the cutter frame 302 cuts deeply into the ground. Cutter frame 302 horizontally cuts sod 101 that can harvested patch 501 and grass strip 502 from field 100. In FIG. 5, cutter blades 301 slices sod 101 in two parallel strips of sod on the field, wide strip and narrow grass trip 502. Harvested patch 501 can be the empty space created after harvester 201 lifts wide strip formed by the cuts made by inner blade 301a and middle blade 301b. Narrow grass strip 502 can be the narrow strip of sod 101 sliced vertically by middle blade 301b and outer blade 301c. As an example, wide sod strip can be 20 inches, while narrow grass strip 502 can be three inches. As each strip is cut, harvester 201 can pick up wide strip for harvesting, leaving patch 501 in its place. Harvested patch 501 can be defined as the space between lines cut by blade 301a and 301c. As patch 501 is cut from field 100, patch 501 can move up through conveyor frame 303 and be kept or stacked for sod production. Concurrently, narrow grass strip 502 can move into guide 304. As shown in the figure, patch 501 and grass strip 502 can be directed at the same time onto conveyor frame 303 and guide 304.

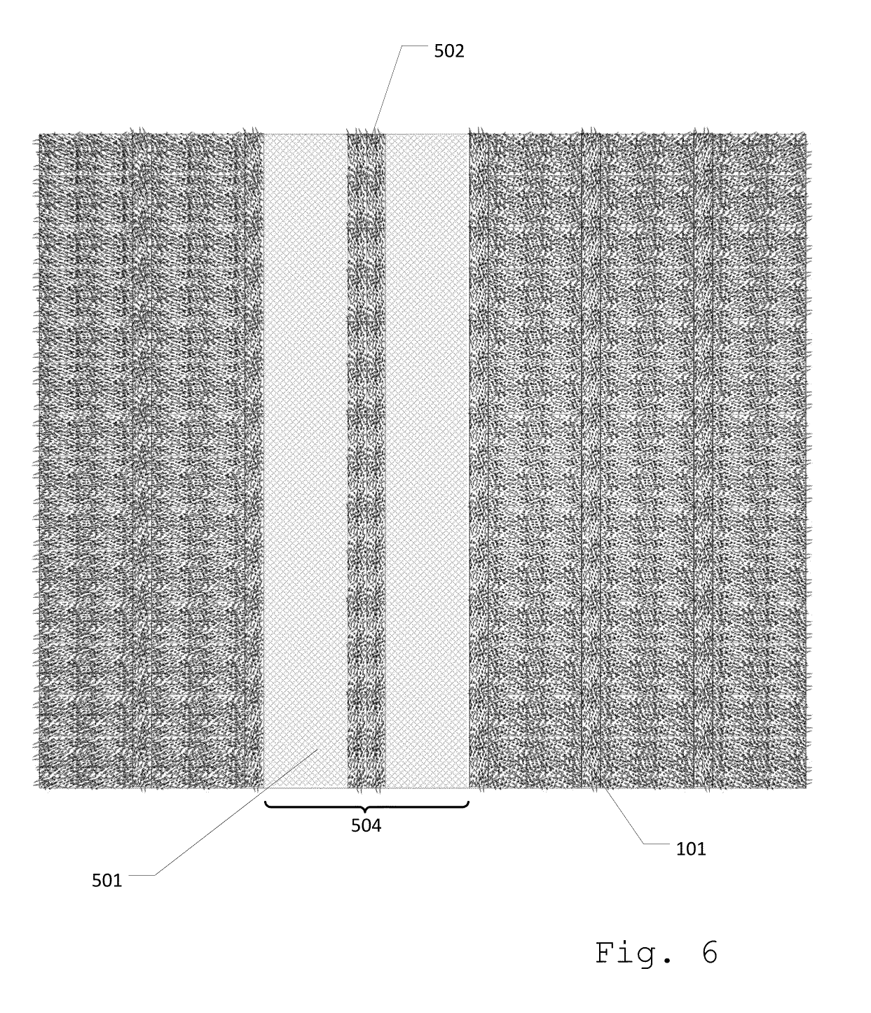

FIG. 6 illustrates an aerial view showing narrow grass strip 502 directed in the middle portion of harvested plot 504. Guide 304 can maneuver grass strip 502 away from the side of harvested plot 504. Additionally, while sod harvester 200 moves through field 100, middle buster 401 can create a trench in harvested plot 500. Simultaneously, narrow grass strip 502 can be aligned over the trench and laid in it. As sod harvester 200 moves along, planter 404 can push narrow grass strip 502 into the trenches, planting narrow grass strip 502. In a preferred method, grass patch 502 can be transplanted in the middle of harvested plot 504, minimizing each gap between grass in field 100. Grass patch 502 can therefore fill up the harvested plot faster, cutting the amount of time needed to propagate a harvested field 100.

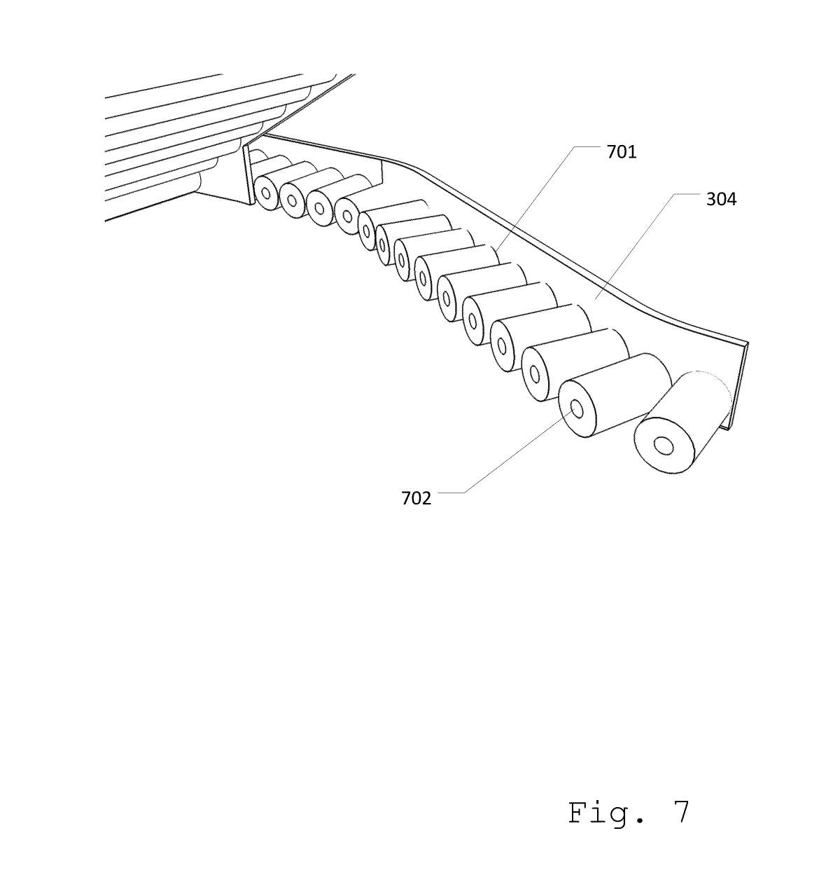

FIG. 7 illustrates an embodiment of guide 304 comprising a plurality of rollers 701. Roller 701 can be a cylindrical tool mounted on the top surface of guide 304. As such, guide 304 can be used as frame where roller 701 can be attached. In such embodiment, guide 304 can further comprise a plurality of axles 702, distributed equally in the surface of guide 304. Axles 702 can be a supporting shaft that roller 701 can mount to. Moreover, axles 702 can be permanently fixed onto guide 304, allowing roller 701 to revolve within axle 702. Rollers 701 can be arranged closely together to ensure that narrow grass strip 502 will not roll or slip in between rollers 701. For purposes of this disclosure, rollers 701 can be manifested as a conveyer belt system.

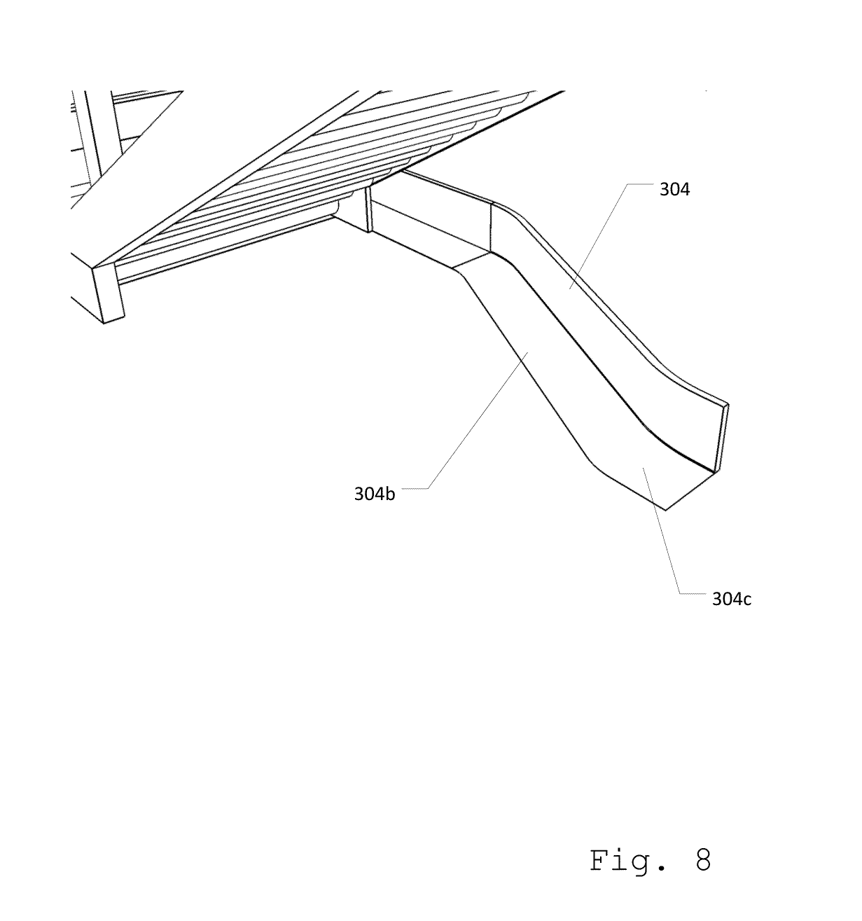

FIG. 8 illustrates an inclined embodiment of guide 304. In such embodiment, middle guide 304b can be bent and form a sliding position onto harvested plot 500. As such, back guide 304c can be near the surface of field 100 forming a vertical end portion of guide 304. In this embodiment, as sod harvester 200 moves forward, narrow grass strip 502 cut through cutter frame 302 can be forced and/or pushed towards guide 304. In such scenario, guide 304 can serve as a device that directs grass strip 502 towards back guide 304c. The sliding design of guide 304 can help grass strip 502 to be maneuvered downward and towards a trench created by middle buster 401.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A harvester guide comprising
a front guide capable of receiving harvested portion of a grass strip;
a middle guide connected to said front guide, wherein said middle guide is curved inward such that at least a portion of said middle guide is positionable under a conveyor frame; and
a back guide connected to said middle guide, wherein said back guide is configured to horizontally displace said grass strip by moving said grass strip through said back guide.

2. The harvester guide of claim 1, wherein a portion of said front guide is mateable with said conveyor frame.

3. The harvester guide of claim 2, wherein a portion of said front guide comprises a first fastener, wherein a portion of said conveyor frame comprises a second fastener, further wherein said first fastener is compatible with said second fastener.

4. The harvester guide of claim 3, wherein said first fastener and second fastener is a clamp mechanism.

5. The harvester guide of claim 3, wherein said first fastener and second fastener is a nut and bolt mechanism.

6. The harvester guide of claim 1, wherein a portion of said front guide is permanently fixed to said conveyor frame.

7. The harvester guide of claim 6, wherein said front guide is connected to said conveyer frame through a weld.

8. The harvester guide of claim 1, wherein said middle guide slopes downward toward said back guide.

9. The harvester guide of claim 1 further comprising a middle buster attached to the bottom of said back guide.

10. The harvester guide of claim 9 further comprising a planter mounted behind said middle buster.

11. The harvester guide of claim 10, wherein said middle buster is capable of creating a trench on said harvested plot, said sod harvester further comprising a wheel mounted on top of said planter capable of flattening said trench.

12. The harvester guide of claim 9, wherein said middle buster is a sweeper.

13. A method for moving a narrow strip of sod on a harvested plot comprising horizontally displacing a grass strip by moving said grass strip through a guide, said guide having a front guide, a middle guide and a back guide, said middle guide curved inward such that at least a portion of said guide is positioned under a conveyor frame.

14. The method of claim 13 further comprising the step of digging a trench with a middle buster attached to said back guide.

15. The method of claim 14 further comprising the step of replanting said grass strip in said trench.

16. The method of claim 15, wherein replanting comprises pushing said grass strip into said trench with a planter attached to said back guide.
